(19) United States
(12) Patent Application Publication
(10) Pub. No.: US 2004/0199433 A1
(43) Pub. Date: Oct. 7, 2004

(54) System and method for capturing conditions of items

(76) Inventor: Richard A Marzan, Allison Park, PA (US)

Correspondence Address: FERENCE & ASSOCIATES, 400 BROAD STREET, PITTSBURGH, PA, 15143, US

(21) Appl. No.: 10/484,539

(22) PCT Filed: Jul. 18, 2001
(86) PCT No.: PCT/US01/22647

(51) Int. Cl. G06F 17/60

(52) U.S. Cl. 705/27

(57) ABSTRACT

A system and method for capturing conditions of items, and in particular remarketed off lease items. According to the invention, it is contemplated that the collection and transfer of information (110) is done electronically to the greatest extent possible, which facilitates handling of the information. Preferably, a global computer network (140) such as the Internet is used to transfer the information.

### TECHNICAL FIELD

This invention is generally directed to a system and method for capturing conditions of items, and in particular remarketed items.

### BACKGROUND ART

For a variety of reasons, the leasing of items—rather than the outright purchase of items—is increasing by end users of the items. In a typical lease transaction, a finance company purchases the item and then leases (or rents) the use of the item to the end user for the term of lease. At the end of the lease term, a number of things typically occur, including the end user relinquishing possession of the item and the item being eventually being remarketed, or sold, by the finance company, which has always maintained title to the item. Also increasing is the practice where an end user purchases an item directly and then after using the item for a period of time, desires to remarket or sell the item. This senario is very similar to a lease, however, the end user is acting as the finance company. These general processes apply to any number of items, including but not limited to vehicles, both cars, trucks and buses; heavy equipment such as lifts, cranes, and fork lifts; construction vehicles; computers; and office equipment. It should be understood the items enumerated herein are intended to be exemplary and not limiting.

In order to facilitate remarketing of an item, however, it is necessary to collect information about the item, the collected information varying depending on the type of item. The information which should be included, however, is that information which potential purchasers would generally want to know about the item in order to decide to purchase the item or that information which the owner of the item would want to know in order to value the item. For example, where the item is a vehicle, the information may include the year, make and model of the vehicle, the vehicle style, the vehicle identification number (VIN), the vehicle mileage, an identification of the options present in the vehicle (power windows, power seats, tape player, CD player, air conditioning, etc.), damage to the vehicle, and pictures of the vehicle. Further background will now be described with reference to the sale or valuation of a vehicle, although it should be understood that similar activity occurs no matter what item is being sold or valued.

The capture of relevant information has been done in the past through manual means, ie., at some point prior to the sale or valuation of the item, a paper condition report is prepared for a vehicle. This condition report has typically included a written summary of relevant information. The condition report is then provided to the relevant entity, typically the finance company, either directly (by mail or equivalent) or facsimile. The condition report may also include visual depictions of the item, such as photographs. Where photographs are taken, they are typically taken with a film camera. In any event, the visual depiction has to then be correlated with the written material relevant to the item of interest. Doing so may be particularly challenging when several of the items are identical in appearance (such as several vehicles of the same model and color).

One approach to the capture of relevant information may be found in commonly owned International Patent Application No. PCT/US01/00941, entitled “System and Method for Remarketing Off Lease Items” and filed on Jan. 14, 2001, which is hereby incorporated by reference.

Accordingly, a need has been recognized in connection with providing an effective manner of collecting and presenting information about the condition of an item.

### DISCLOSURE OF THE INVENTION

In accordance with the present invention, there is provided a greatly improved system and method for collecting and presenting information about the condition of items, which also results in decreased costs, cycle time, and improved efficiency. According to the invention, it is contemplated that the collection and transfer of information be done electronically in an integrated manner to the greatest extent possible, which facilitates handling of the information. Preferably, a global computer network such as the Internet is used to transfer the information.

In summary, one aspect of the invention provides a method of obtaining information relating to the condition of at least one item, said method comprising the steps of: providing an accessible electronic medium; formulating a description relating to at least one item and entering the description in the accessible electronic medium, the description being suitable to assist in the valuation of the at least one item; facilitating access to the accessible electronic medium in a manner to permit at least one authorized user to access the description.

Additionally, one aspect of the invention provides a system for obtaining information relating to condition of at least one item, said system comprising: an accessible electronic medium; an arrangement for formulating a description relating to at least one item and for facilitating entry of the description into the accessible electronic medium, the description being suitable to assist in the valuation of the at least one item; and an arrangement for facilitating access to the accessible electronic medium in a manner to permit at least one authorized user to access the description.

Additionally, one aspect of the invention provides an apparatus for obtaining information relating to the condition of at least one item, said apparatus comprising: an arrangement for electronically formulating a description relating to at least one item; the description being suitable to assist in the valuation of the at least one item; and an arrangement for permitting at least one authorized user to access the description relating to the at least one item to assist in the valuation of the at least one item.

Additionally, one aspect of the invention provides an apparatus for the display of information relating to the condition of at least one item, said apparatus comprising: a display; an arrangement for producing information for being displayed on said display, said information relating to the condition of the at least one item; an arrangement for producing information for being displayed on said display, said information relating to the visual representation of the at least one item; an arrangement for producing information for being displayed on said display, said information relating to any damage to the physical condition of the at least one item; and an arrangement for producing information for being displayed on said display, said information relating to options associated with the at least one item.

Additionally, one aspect of the invention provides a program storage device readable by machine for tangibly embodying a program of instructions executable by said machine to perform a method for obtaining information relating to the condition at least one item, said method comprising the steps of: providing an accessible electronic medium; formulating a description relating to at least one item and entering the description in the accessible electronic medium, the description being suitable to assist in the valuation of the at least one item; facilitating access to the accessible electronic medium in a manner to permit at least one authorized user to access the description.

### BRIEF DESCRIPTION OF THE DRAWINGS

FIG. 1 is an overall system block diagram of a preferred embodiment of the present.

FIG. 2 is an overall system block diagram of another preferred embodiment of the present invention.

FIG. 3 is an overall system block diagram of a system controller.

FIGS. 4a through 4c show the schema for the relational data maintained within the system controller.

FIG. 5 is an overall system block diagram of a collection device.

FIG. 6 shows the schema for the relational data maintained with the collection device.

FIG. 7 is a flow chart showing the overall process involved in completing a condition report.

FIG. 8 shows assignment of the preparation of condition reports within the system controller.

FIGS. 9a through 9j show the display of collection device 110 at various stages in the preparation of a condition report.

FIG. 10a shows a completed condition report, with the information on the condition of the vehicle being displayed

FIG. 10b shows a completed condition report, with the information on the photo of the vehicle being displayed

FIG. 10c shows a completed condition report, with the information on the damage to the vehicle being displayed.

FIG. 10d shows a completed condition report, with the information on the options on the vehicle being displayed.

FIG. 11 shows prepared condition reports awaiting approval within the system controller.

### MODES FOR CARRYING OUT THE INVENTION

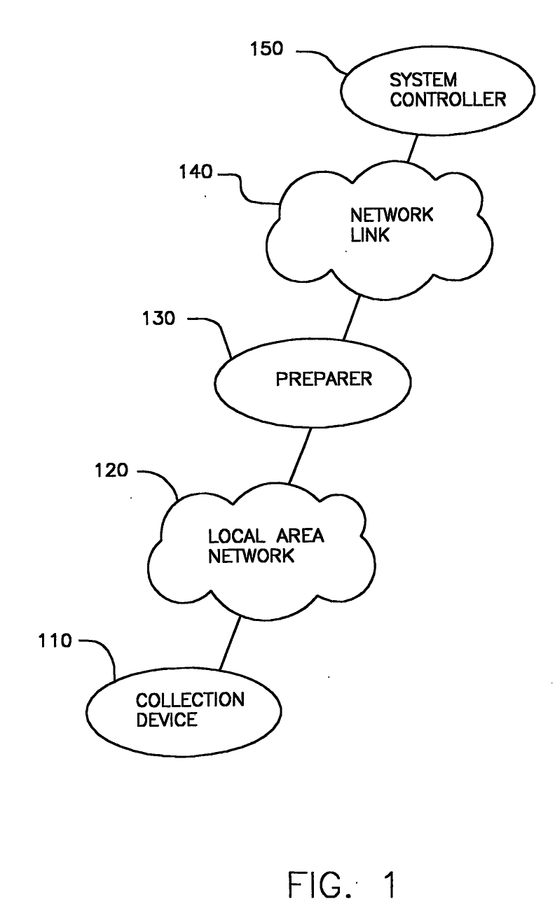

FIG. 1 is an overall system block diagram of a preferred embodiment of the present invention. In this embodiment, the participants are linked to the system provider electronically. As shown, the linked participants are collection device 110, preparer 130, and system controller 150. The links 120 and 140 do not have to be physical links—they can, for example, be a link via a global computer network, such as the Internet, and include a virtual private network. The link 120 between collection device 110 and preparer 130 is preferably a wireless local area network. This permits the movement of collection device 110 not to be limited by wires. Preferably, the link 140 is a global communications network, such as the Internet. Use of a global communications network reduces the cost of implementing the present invention since a private communications network need not be provided, while increasing the geographic range of potential participants. Alternatively, link 140 can be a private communications network, or other appropriate means, such as a direct dial modem connection. The link may also be a secure link, secured for example, through cryptography.

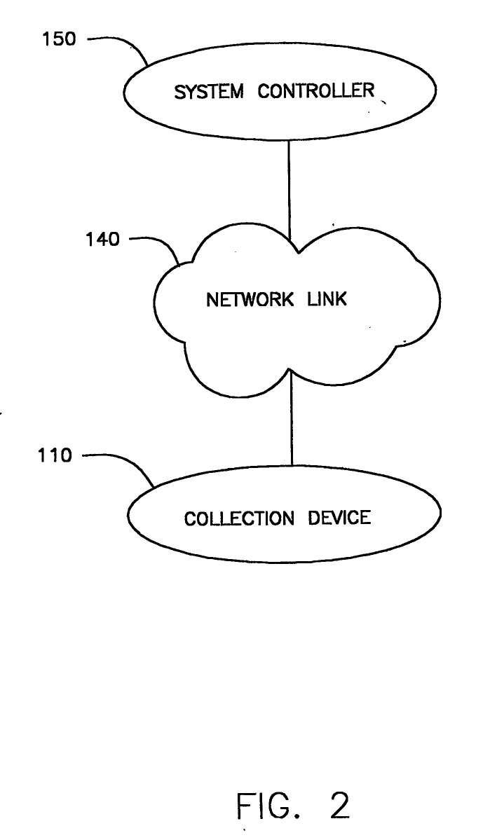

FIG. 2 is an overall system block diagram of another preferred embodiment of the present invention. As before, the participants in the system are linked to the system provider electronically. Moreover, like reference numerals are used to denote like components. As shown, the linked participants are collection device 110 and system controller 150. This embodiment permits the collection device 100 to communicate directly with the system controller 150 through link 140.

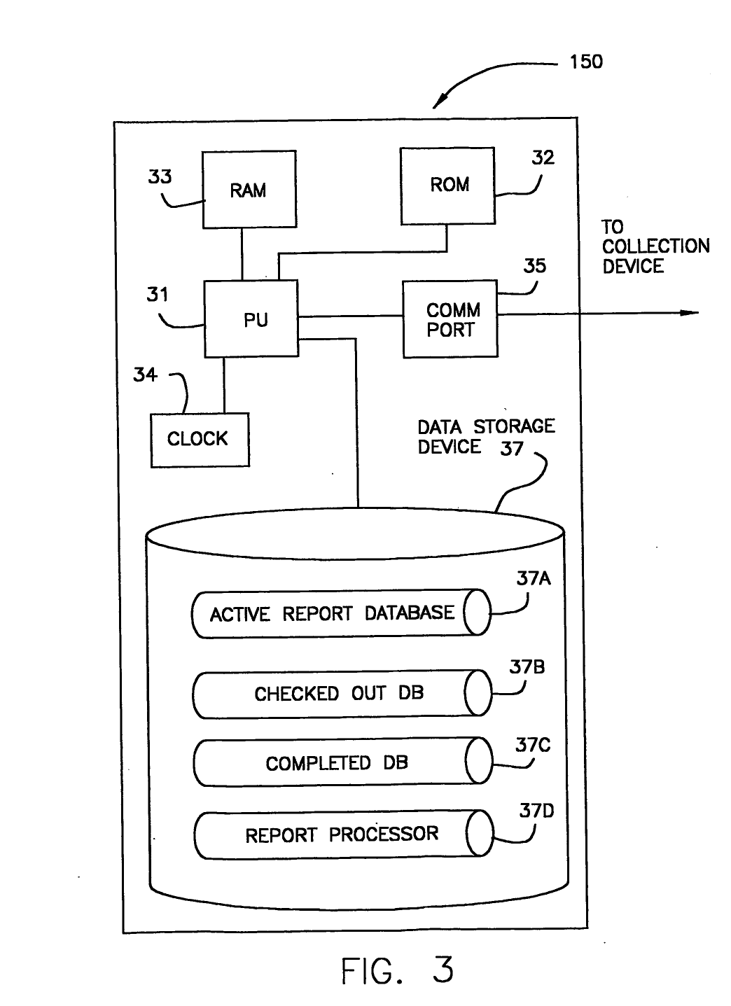

FIG. 3 is a block diagram of a preferred system controller 150. The system controller includes a CPU 31 which performs the processing functions of the controller. It also includes a read only memory (ROM) 32 and a random access memory 33 (RAM). The ROM 32 is used to store at least some of the program instructions that are to be executed by the CPU 31, such as portions of the operating system or BIOS, and the RAM 33 is used for temporary storage of data. A clock circuit 34 provides a clock signal which is required by the CPU. The use of a CPU in conjunction with ROM, RAM, and a clock circuit is well known to those skilled in the art of CPU based electronic circuit design.

The system controller 150 also includes a includes a communication port 35 which enables the CPU 31 to communicate with devices external to the system controller 150. In particular, the communications port 35 facilitates communication between the network link 140 and the CPU 31, so that information arriving from the network link 140 can be processed by the CPU 31, and the CPU 31 can send information to remote locations via the network link 140.

While the illustrated embodiment uses network link 140 to communicate with devices outside of the system controller 150, it should be understood that other methods of communicating with external devices may be used instead of a network link. These other methods include a modem, hard-wired connections, radio communications, optical communications, and the like.

The CPU 31 can also store information to, and read information from, the data storage device 37. This data storage device 37 includes active report database 37a, a checked out database 37b, and a completed database 37c, which are discussed below. In addition, it includes report processor instructions 37d which can be read by and executed by the CPU 31, thereby enabling the CPU 31 to process reports. While FIG. 3 depicts separate active report, checked out, and completed, a single database that incorporates these functions can be used.

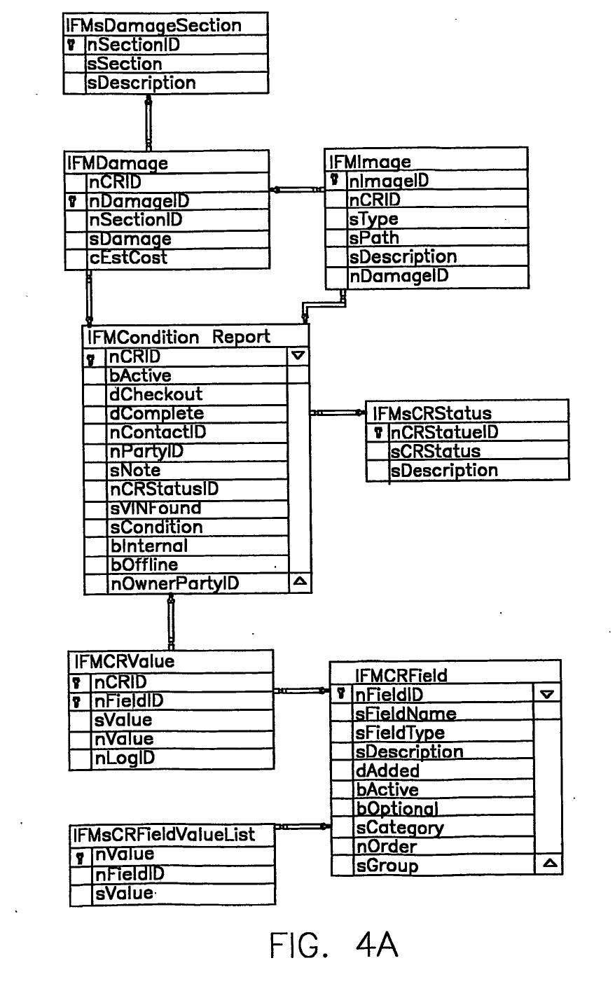

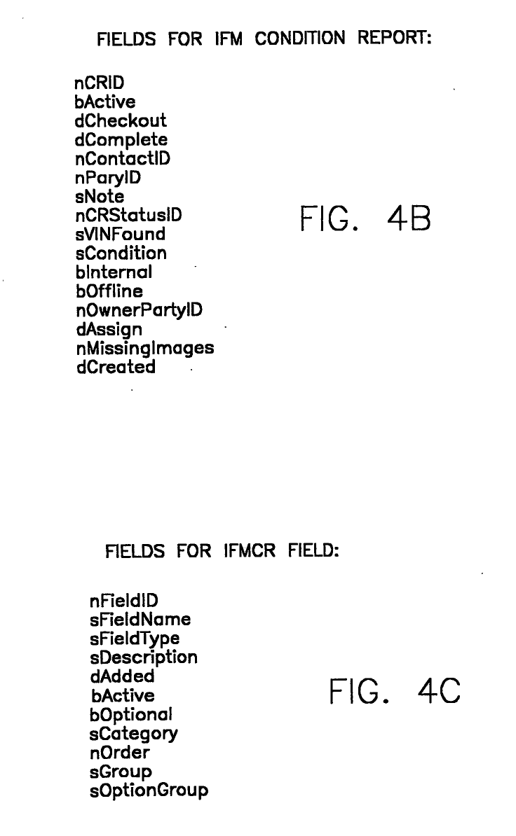

FIG. 4a shows the relational database schema for the information maintained in databases 37a, b, and c. It should be noted that not all the information contained within tables 4-1 and 4-2 is shown in this figure. A complete listing of the information contained within these tables is shown in FIGS. 4b and 4c, respectively.

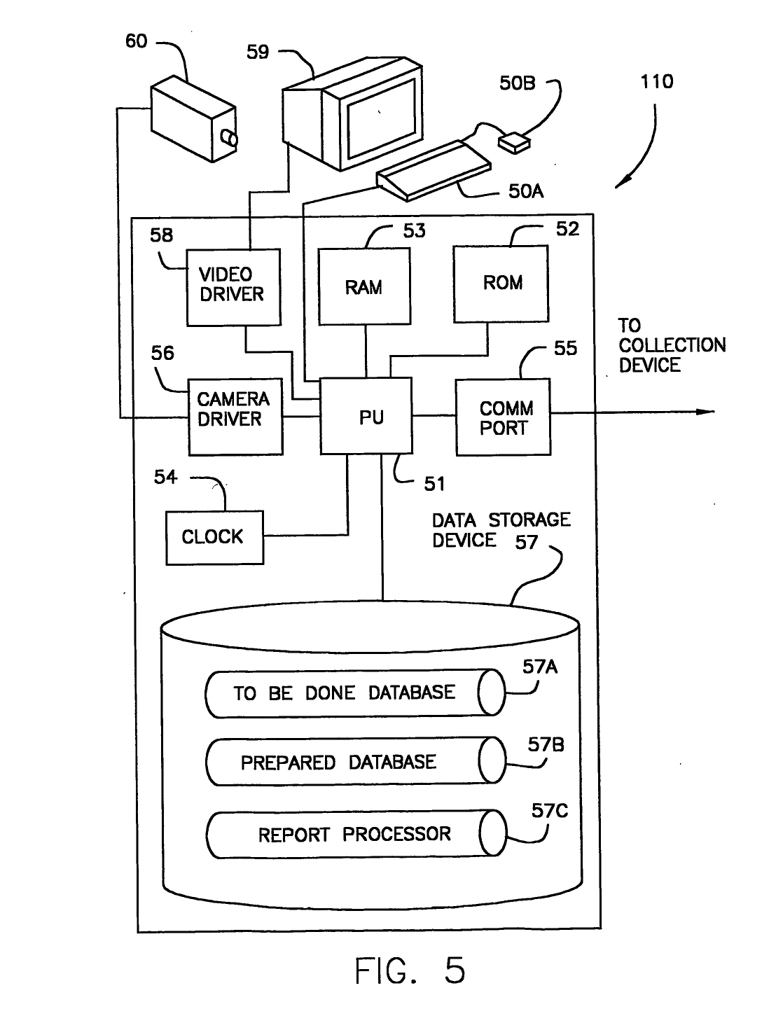

FIG. 5 is a block diagram of a preferred collection device 110, which can be located at any location. For example, collection device 110 may be used as part of a local area network as shown in FIG. 1, as part of a network as shown in FIG. 2, or as a stand alone unit, provided a network connection is available at some point in time. There can be any number of collection devices 110 linked up to system controller 150. Like the system controller 150 described above, the collection device 110 includes a CPU 51, ROM 52, RAM 53, and a clock circuit 54. The collection device 110 also includes a communication port 55 which interfaces with network link 140 that facilitates communication between the collection device 110 and the system controller 150. Of course, instead of the network link 140 depicted in the drawings, other ways of communicating can be used, as described above for the system controller 150.

The collection device 110 also includes an input device 50 to receive input from an operator. Any of a wide variety of input devices would be suitable for this purpose, including, for example, keyboards, mice, touch screens, and the like. The input device 50 may interface directly with the CPU 51. Alternatively, an appropriate interface circuit may be placed between the CPU 51 and the input device 50.

The collection device 110 also includes a video display 59 for conveying information to the operator. The display varies according to the nature of collection device 110. The display device, however, may be a CRT, although other devices including LCD, LED, and thin films transistor panels may be used. Individual indictors may also be used to convey information to the operator, including incandescent and neon lamps, LEDs, and the like. A video driver 58 interfaces the CPU 51 to the video display.

The collection device 110 also includes a video camera 60 for capturing images of items. While any functional camera is acceptable, it preferred the camera be integral with collection device 110. A camera driver 56 interfaces the CPU 51 to the video camera.

The collection device 110 also includes a data storage device 57, which includes database 57a of reports to be done and database 57b of prepared (or completed) reports. In addition, it includes database 57c in which processor instructions are stored. These instructions can be read and executed by the CPU 31 to process reports.

A standard computer such as an IBM PC or an Apple Macintosh, running appropriate software may be used as the collection device, although a VAIO® C1 PictureBook™ notebook computer from Sony is presently preferred. Capturing information using a portable personal computer with an integrated digital camera, such as a VAIO® C1 PictureBook™ notebook computer from Sony, permits the images to associated with the proper item at the time the image is taken. This greatly reduces the possibility of error, which may arise, for example, when the image is taken separately from the collection of other data, and then is later manually associated with the other data. It should also be recognized that a digital camera linked to a portable personal computer would also be preferred to subsequent manual association of the image with the data. Using a portable personal computer as the collection device 110 also permits text to be entered directly into the condition report at the time the vehicle is viewed.

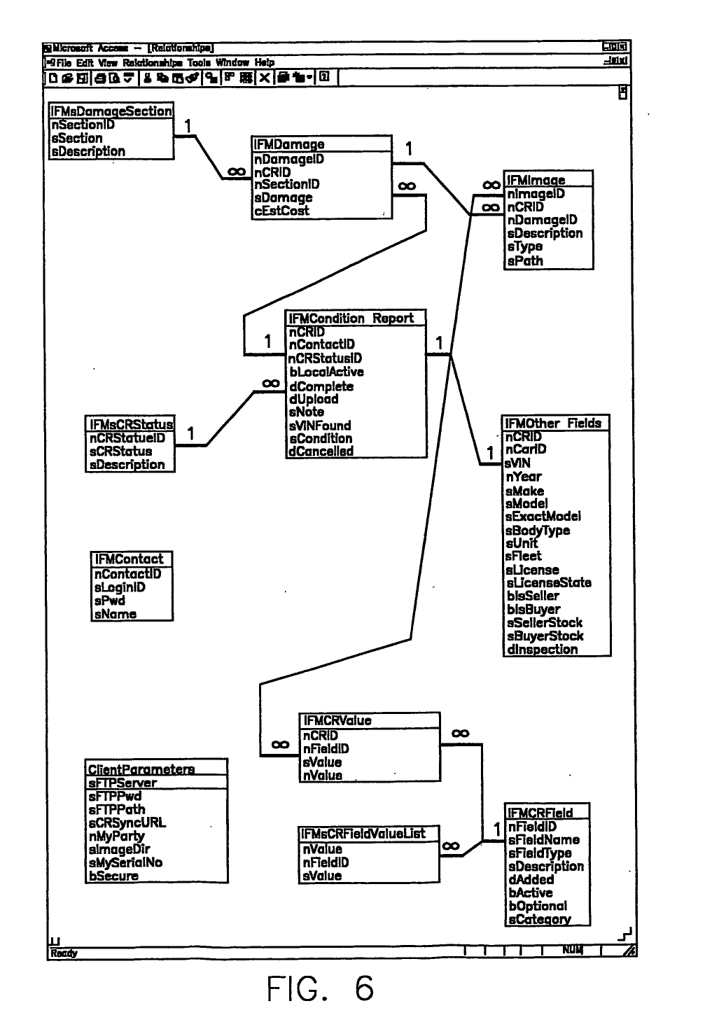

FIG. 6 shows the relational database schema for the information maintained in databases 57a and b

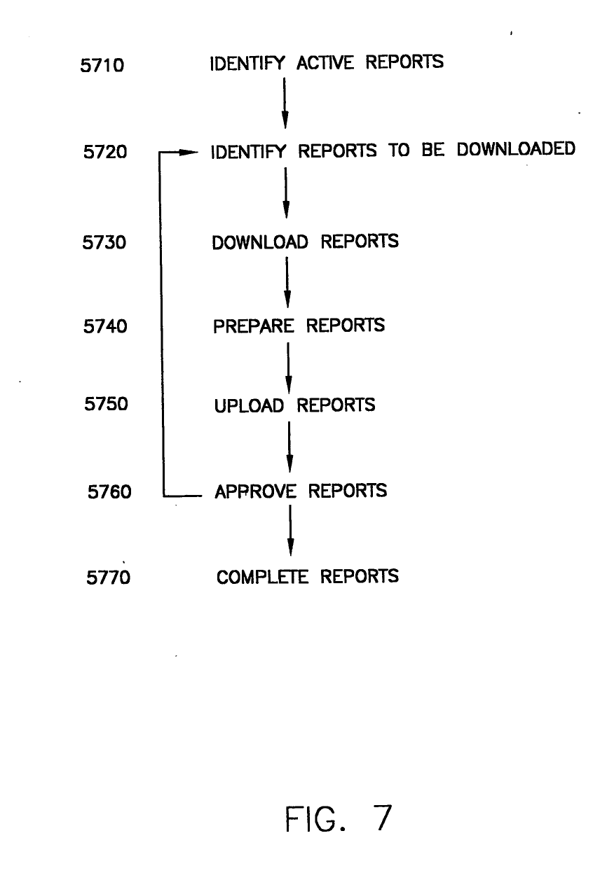

FIG. 7 is a flow chart depicting the initiation of an electronic condition report. At S710, active reports are identified. An active report is a vehicle which is ready to have a condition report done. Any number of criteria may be used to identify such vehicles, as determined by the system operator. Information on active reports is maintained in database 37a (active reports). At S720, the reports to be downloaded are identified. Information on these reports is maintained in database 37b (checked out reports). This database contains information on 1) those reports awaiting download, 2) those reports awaiting processing, 3) those reports which have been uploaded, and 4) those reports which are awaiting approval, as discussed below.

At S730 reports are downloaded from system controller 150 to collection device 110. Information on downloaded reports is maintained in database 57a (reports to be done). At S740 the reports are prepared. Information on prepared reports is maintained in database 57b (prepared or completed reports). At S750 prepared reports are uploaded to system controller 150. Information on prepared reports is maintained in database 37b (checked out reports).

At S760 prepared reports are approved. As presently preferred, approval involves reviewing the prepared report for completeness, including internal inconsistencies. By way of example, it is presently preferred that each prepared report include at least four images of the vehicle: front angle, rear angle, interior (typically from driver's side), and odometer. In addition, images of any damage should also be included. If these images were not included, or the images were of poor quality (i.e., taken directly into the sun), the prepared report would not be approved. The report would also not be approved if there were internal inconsistencies in the report, e.g., damage was reported but no images of the damage areas were included in the report. Approval may either be a manual process or an automated process, depending on the preference of the system operator. Should a prepared report not be approved, the report is identified as a report for subsequent download.

At S770, completed reports are identified. Information on completed reports is maintained in database 37c. A completed report is a condition report which has been approved.

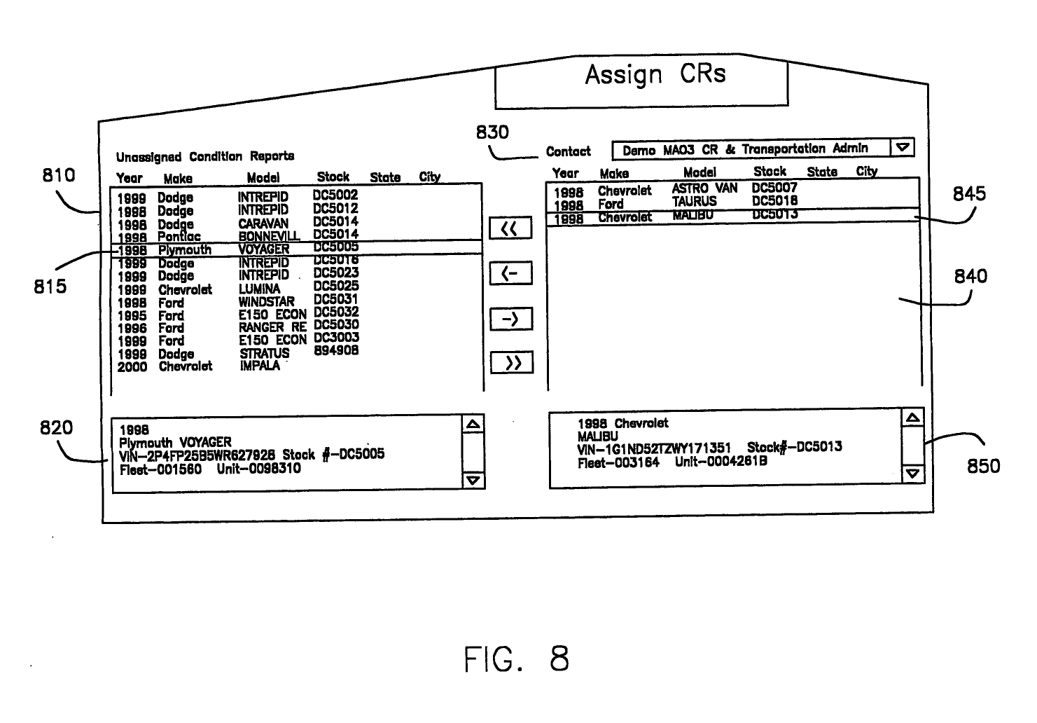

FIG. 8 shows the assignment of the preparation or checking out of condition reports to a particular individual (Demo MA03CR & Transportation Admin). At reference numeral 810, a listing of vehicles for which the preparation of a condition report has not yet been assigned. While the items shown are vehicles, the items may be any appropriate item. For one particular item 815, details on the item are shown at reference numeral 820. At reference numeral 830, a preparer of condition reports is identified. At reference numeral 840 the items for which the preparer is to prepare condition reports are listed. For one particular item 845, details on the item are shown at reference numeral 850. Once assignment of a condition report has been made, the preparer is notified, preferably electronically and the system controller preferably tracks whether or not a completed condition report has been returned, as discussed above.

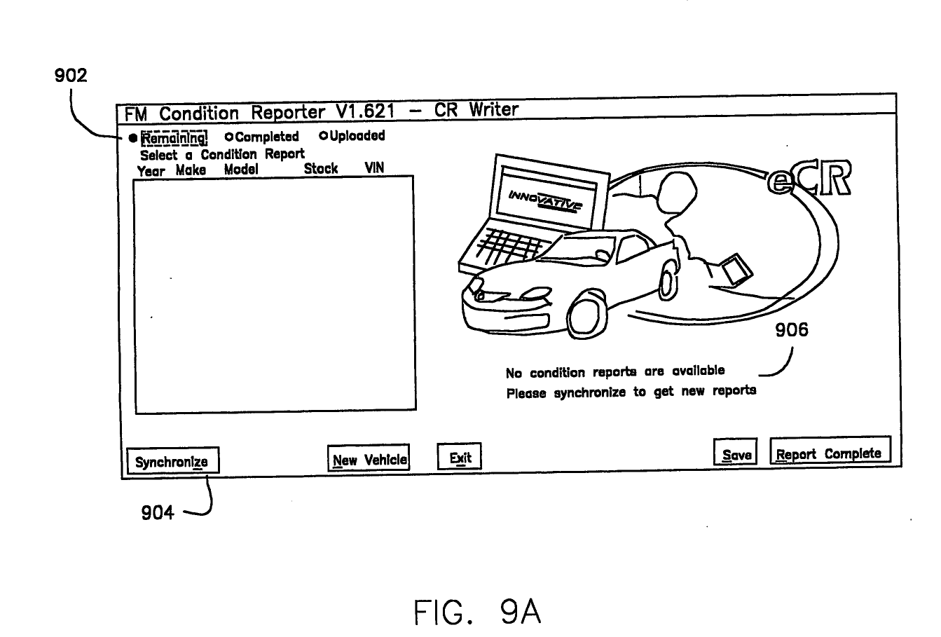

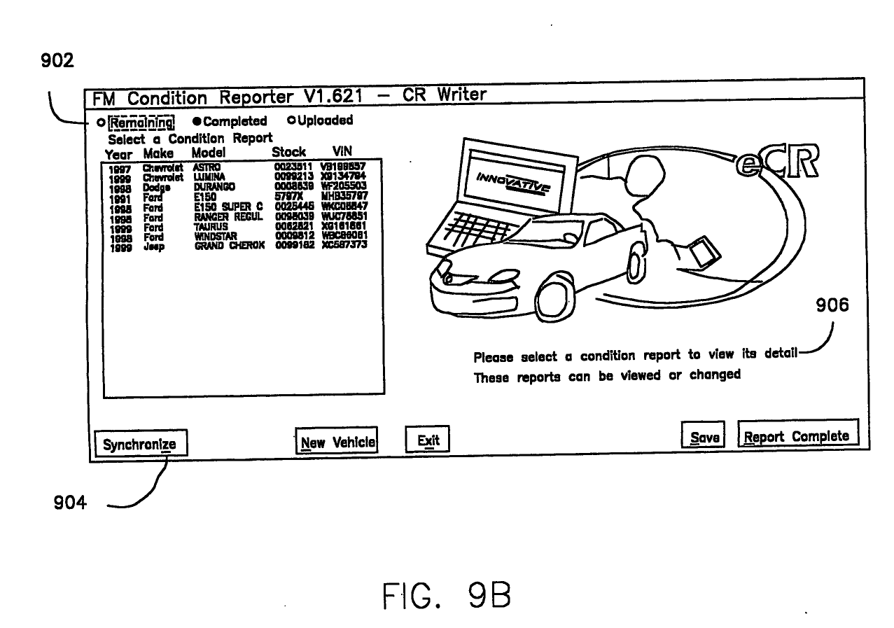

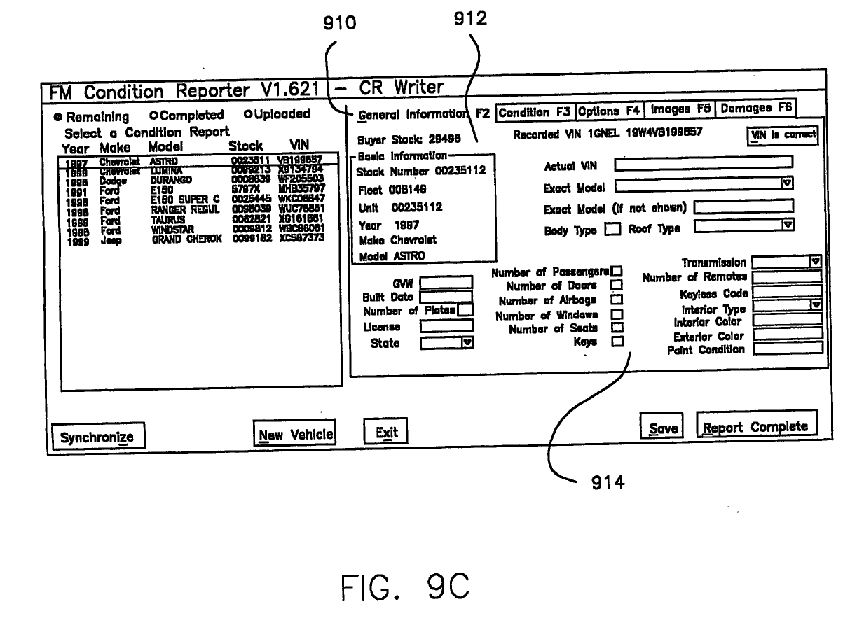

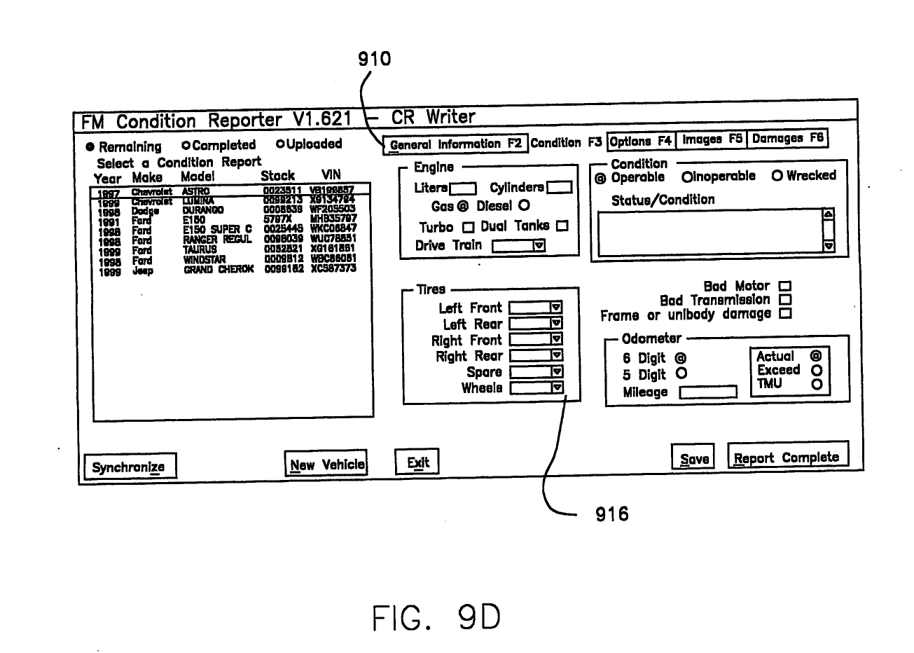

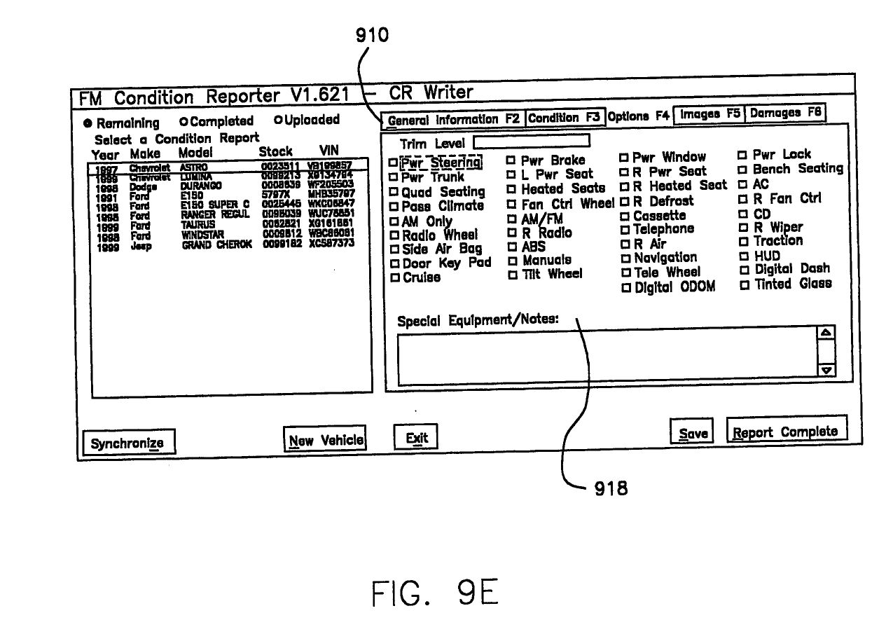

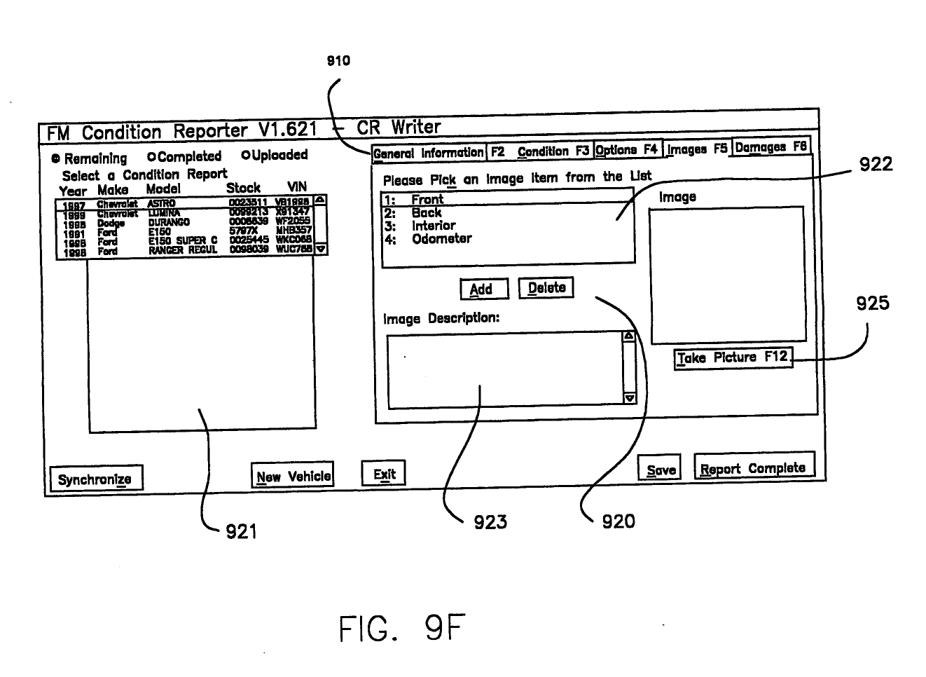

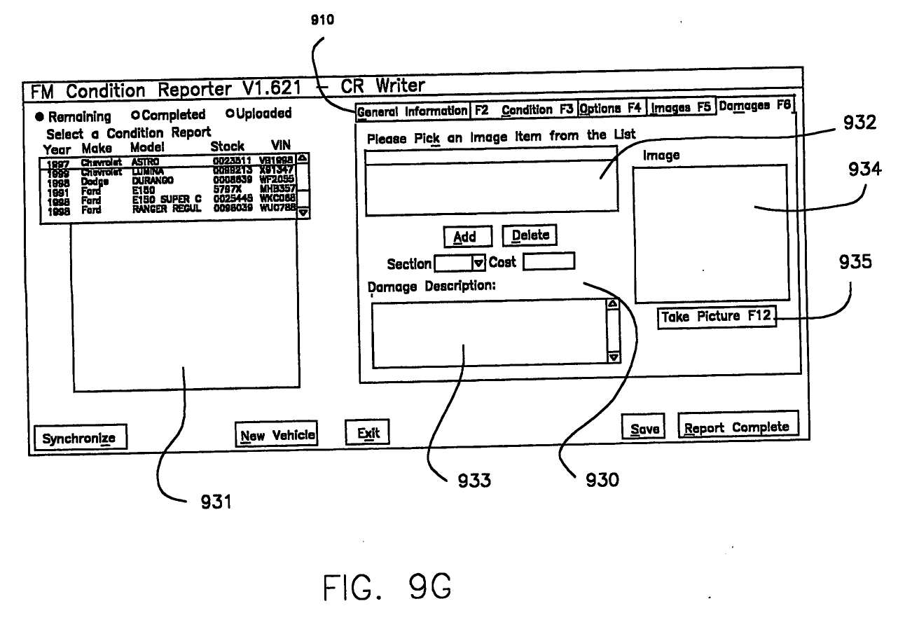

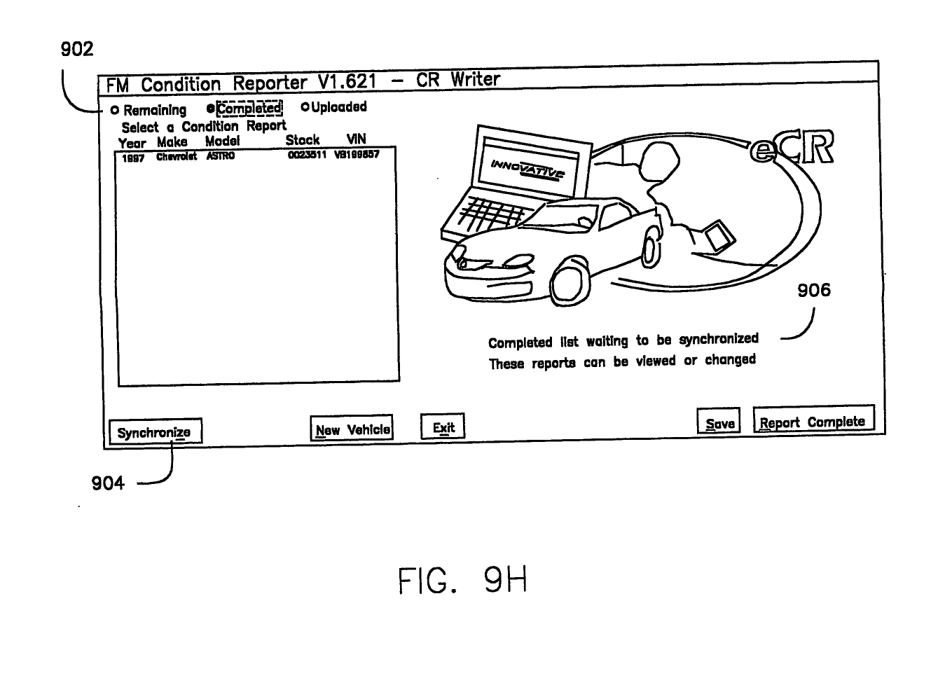

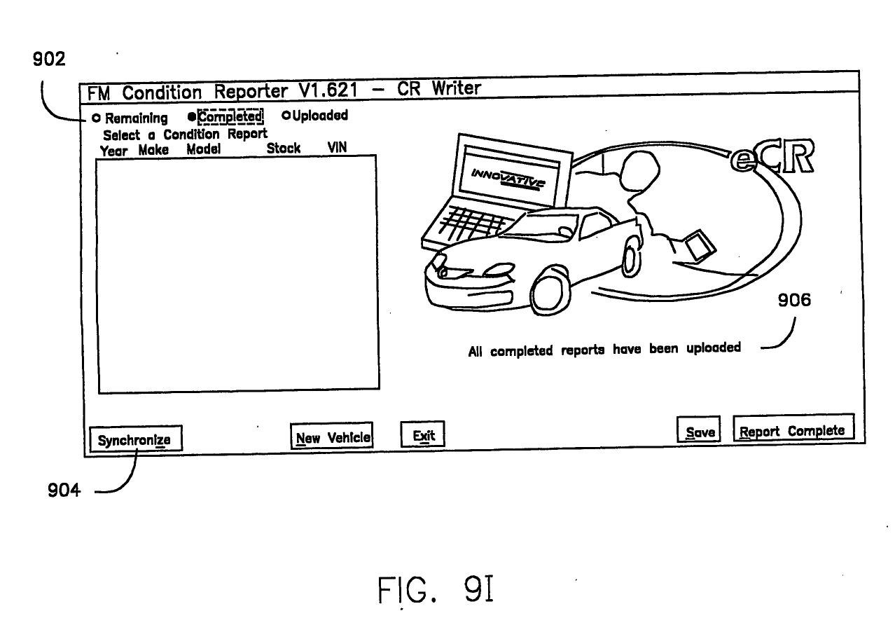

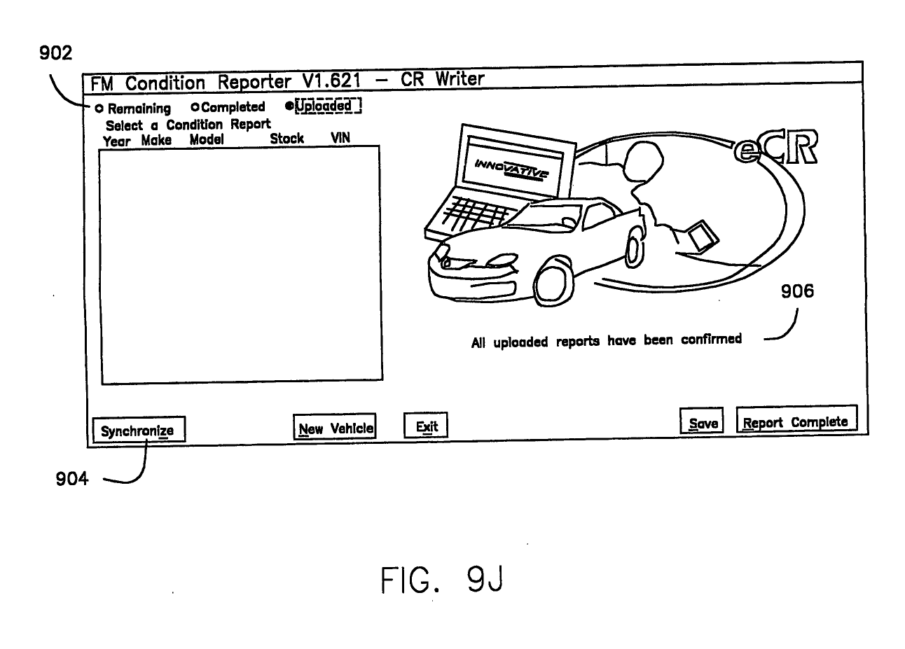

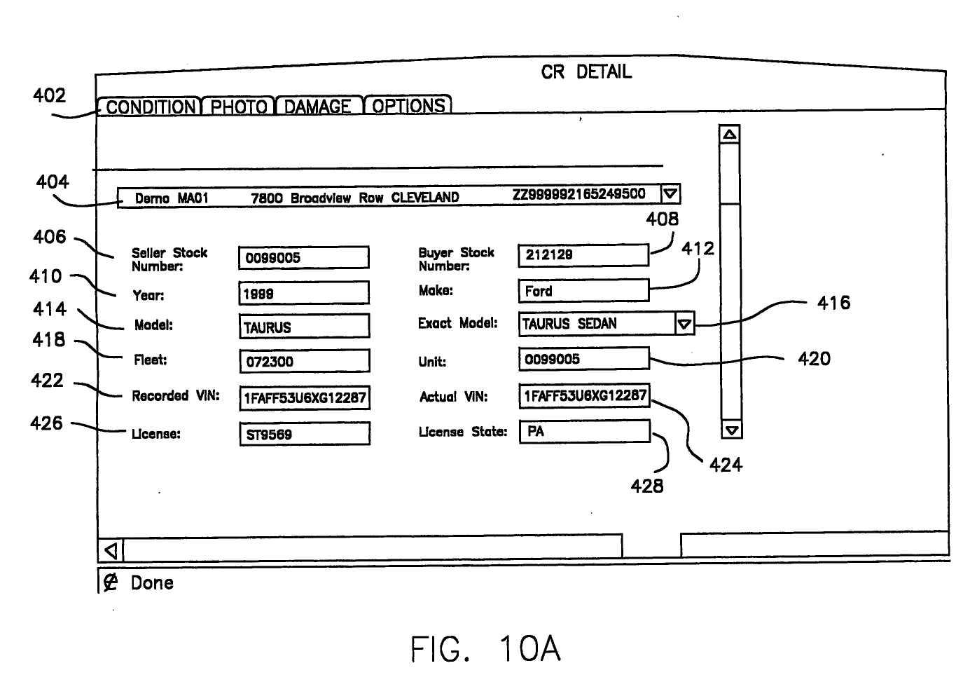

FIG. 9a shows what a preparer sees upon activating collection device 110. At reference numeral 902 the types of reports being viewed are identified. At reference numeral 904, several buttons are provided to perform different functions. At reference numeral 906, information is provided on the current state of collection device 110.

FIG. 9b shows the display of collection device 110 after synchronization (downloading and/or uploading) from system controller 150 has occurred. In accordance with the information provided at reference numeral 906 in FIG. 9a, synchronization was started by pressing the synchronization button at reference numeral 904. At reference numeral 908, vehicles for which condition reports need to be prepared are displayed. The operator of collection device 110 preferably selects a vehicle.

At reference numeral 910, tabs for various types of information are shown and are labeled General Information, Condition, Options, and Damages. The General Information tab is selected in this figure. At reference numeral 912 certain information transferred from system controller 150 is displayed. This information includes a buyer stock number, the recorded vehicle identification number (VIN), and other basic information. At reference numeral 914, entry is provided for specific information about the selected vehicle. As shown, this information includes: actual VIN, exact model, exact model (if not shown), body type, roof type, transmission, gross vehicle weight (GVW), built date, number of plates, license, state, number of passengers, number of doors, number of airbags, number of windows, number of seats, keys, number of remotes, keyless code, interior type, interior color, exterior color, and paint condition. The area denoted by reference numeral 904 now includes a button to save the information entered into the area denoted by reference numeral 914.

FIG. 9d shows the display of collection device 110 with the Condition tab selected at reference numeral 910. At reference numeral 916 information relating to the condition of the vehicle is entered. The information preferably relates to four categories: engine, condition, tires, and odometer. Information preferably collected for the engine category includes liters, cylinders, gas, diesel, turbo, dual tanks, and drive train. Information preferably collected for the condition category includes operable, inoperable, wrecked, any additional information deemed relevant by the preparer, bad motor, bad transmission, and frame or unibody damage. Information in tire category is preferably collected for the left front, left rear, right front, right rear, spare, and wheels. Such information would typically include an indication of whether the item is in good, fair, or poor condition or needs replaced. Information preferably collected in the odometer category includes whether the odometer is five or six digits, the mileage shown on the odometer, whether this is the actual mileage, whether the capacity of the odometer has been exceeded (i.e., rolled over), and whether the true mileage is unknown (TMU). True mileage may be unknown if the odometer is missing, shows signs of being tampered with, shows signs of having been replaced, or the like.

FIG. 9e shows the display of collection device 110 with the Options tab selected at reference numeral 910. At reference numeral 918 information relating to the options on the vehicle is entered. The trim level, if known, may also be entered. When manufacturer's trim codes are used, it may be preferable to autofill the options selections. A space is also preferably provided for an entry on special equipment and/or notes.

FIG. 9e shows the display of collection device 110 with the Images tab selected at reference numeral 910. At reference numeral 920 information relating to images of the vehicle is entered. As shown at reference numeral 922, a number of standard images positions are shown for selection. At reference numeral 924, the image (if any) associated with the selected position is displayed. At reference numeral 923, a textual description of the image, if desired, may be entered. At reference numeral 921, the image currently being viewed by video camera 42 is shown. This image is preferably associated with the selected position through the use of the “Take Picture” button at reference numeral 925.

FIG. 9g shows the display of collection device 110 with the Damages tab selected at reference numeral 910. At reference numeral 930 information relating to the condition of the vehicle is entered. As shown at reference numeral 932, standard images positions may be shown for selection. At reference numeral 934, the image (if any) associated with the selected position is displayed. At reference numeral 933, a textual description of the image, if desired, may be entered. At reference numeral 931, the image currently being viewed by video camera 42 is shown. This image is preferably associated with the selected position through the use of the “Take Picture” button at reference numeral 935.

FIG. 9h shows what a preparer sees upon completion of a condition report, as at reference numeral 902 the types of reports being viewed is identified as “Completed”. At reference numeral 908 those vehicles for which the reports have been completed are listed. At reference numeral 904, several buttons are provided to perform different functions. At reference numeral 906, information is provided on the current state of collection device 110.

FIGS. 9i and 9j show the display of collection device 110 during synchronization (downloading and/or uploading) from system controller 150. In accordance with the information provided at reference numeral 906 in FIG. 9i, synchronization was started by pressing the synchronization button at reference numeral 904 to effect an uploading of the completed reports to system controller 150. Reference numeral 902 in FIG. 9j shows information for uploaded reports. At reference numeral 906 in FIG. 9j, a message is displayed that all uploaded reports have been confirmed.

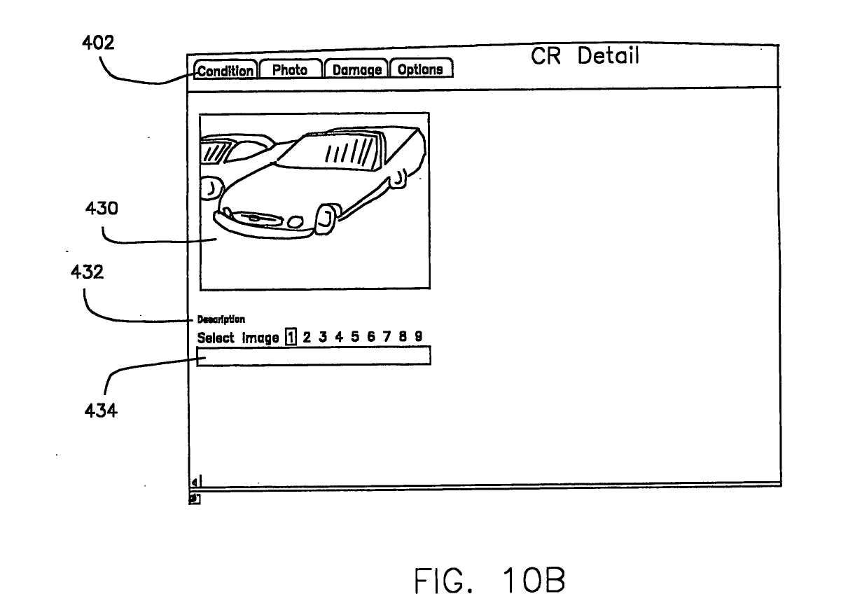

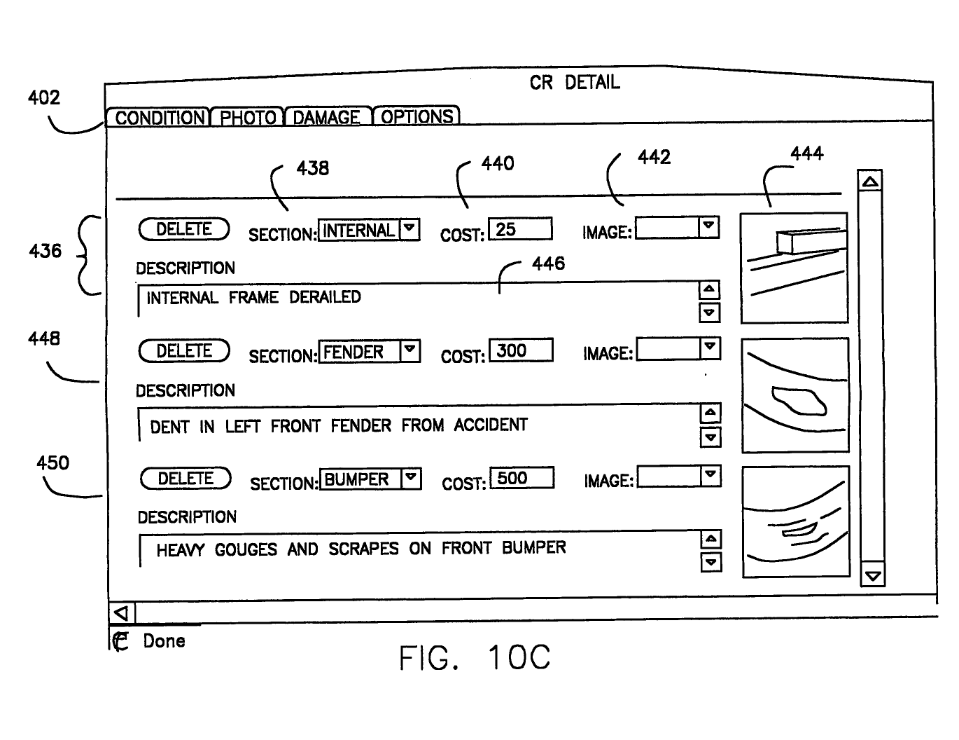

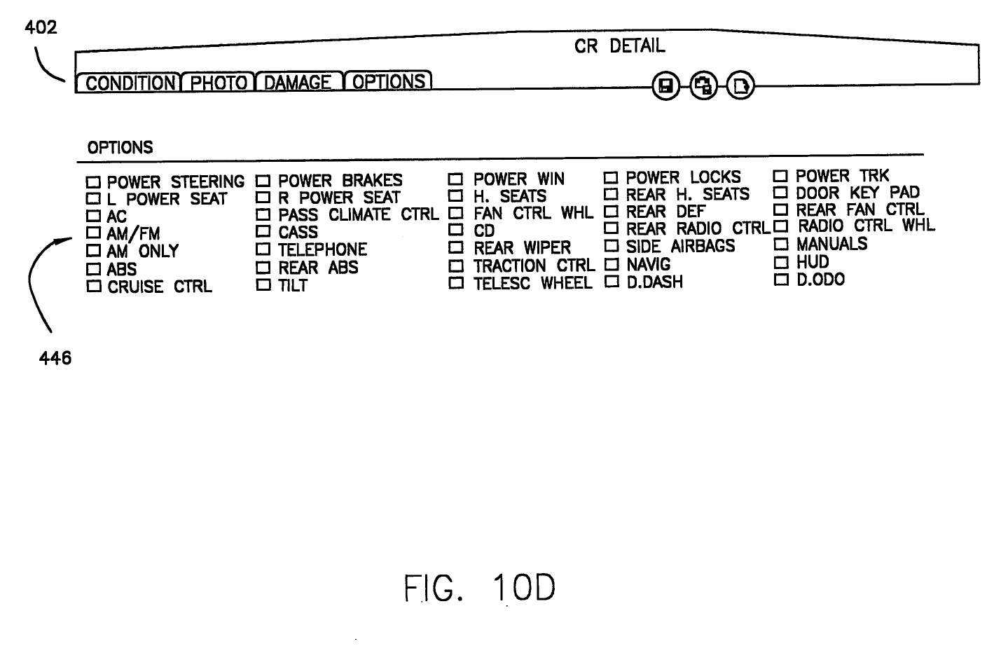

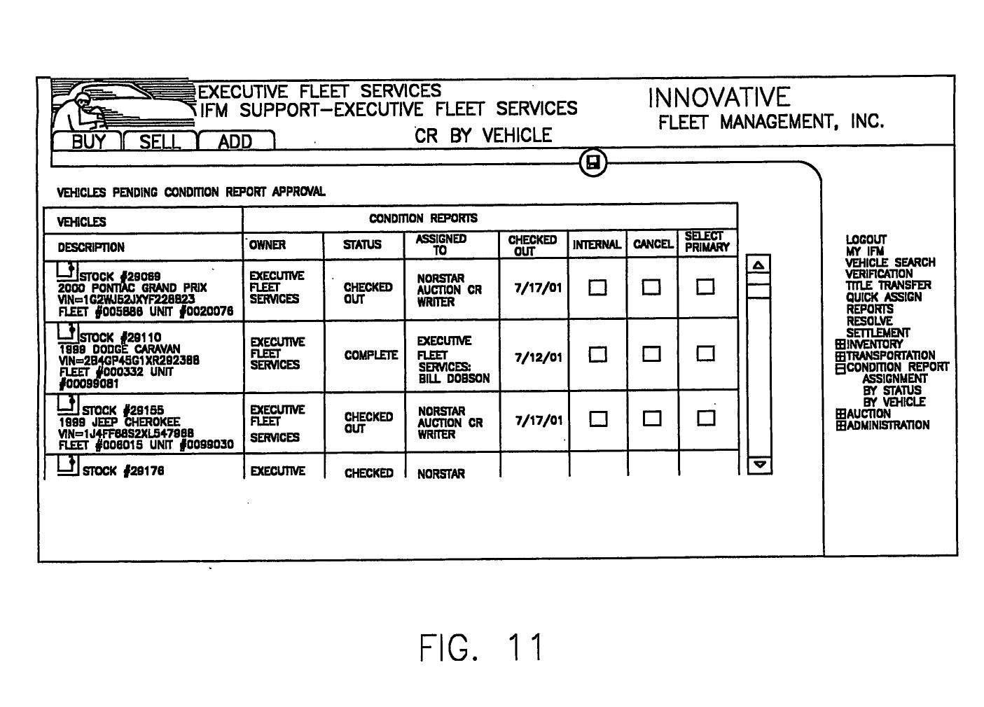

FIG. 10a shows a completed condition report, with the information on the condition of the vehicle being displayed. A completed condition report preferably comprises several different types of information, which are reflected in FIG. 10a at reference numeral 402 and are labeled condition, photo, damage, and options. At reference numeral 404 the entity which prepared the condition report is indicated. At reference numeral 406 the seller stock number is shown, which is preferably assigned. by the buyer of the vehicle. At reference numeral 408, the buyer stock number is shown, which is preferably assigned at the first level of transactions. At reference number 410 the year of the vehicle is shown. At reference number 412 the manufacturer of the vehicle is shown. At reference number 414 the model of the vehicle is shown. At reference number 416 the exact model of the vehicle is shown. At reference numeral 418 a numeric identification of the title owner of the vehicle is shown. At reference numeral 420 a unit identifier is shown. A unit is a supplier's classification of their asset. At reference numeral 422 the vehicle identification number (VIN) of the vehicle recorded in the system provider's records is shown. At reference numeral 424 the actual VIN is shown. At reference numeral 426 the license plate of the vehicle is shown. At reference numeral 428 the state in which the license plate was issued is shown.

FIG. 10b shows a completed condition report, with the information on the photo of the vehicle being displayed as indicated at reference numeral 402. An image of the vehicle appears at reference numeral 430, with a spot for a description to be associated with the vehicle at reference numeral 432, and the image associated with the vehicle being viewed at reference numeral 434. While unlimited images may be supported, the preferable images are of the front of the vehicle, the rear of the vehicle, the vehicle odometer, and the vehicle interior.

FIG. 10c shows a completed condition report, with the information on the damage to the vehicle being displayed as indicated at reference numeral 402. Reference numerals 436, 448, and 450 each denote information for a particular area of damage. Information on additional areas of damage may also be provided. Each set of information for a particular damage contains distinct information, which will now be explained with reference to reference numeral 436. At reference numeral 438, the section of the vehicle for which the work needs to be done is identified. In this example, the section is clean up. Other sections may include, without limitation, cleanup, glass, interior, mechanical, other, paint, prior repairs, and tires. At reference numeral 440, an estimate of the cost of repair is shown. Preferably, this estimate is provided by the person operating the collection device. At reference numeral 442, a filed for future use is provided. At reference numeral 444, an image associated with the area of damage is shown. It is possible to associate multiple images with different entries.

FIG. 10d shows a completed condition report, with the information on the options on the vehicle being displayed as indicated at reference numeral 402. At reference numeral 446, a number of options are listed. Preferably, these options may be check by the person operating the collection device 110. The options may also be keyed specifically by vehicle.

FIG. 11 shows prepared condition reports awaiting approval. Three options are provided for each prepared condition report: internal; cancel, and select primary. Internal means the prepared condition report is marked for the internal use only by the entity charged with approval. Cancel means the condition report is being cancelled for some reason. Select primary equates with the prepared condition report being approved.

While there have been described what are believed to be the preferred embodiments of the invention, those skilled in the art will recognize that other and further modifications may be made thereto without departing from the invention and it is intended to claim all such changes and modifications as fully within the scope of the invention.

What is claimed is:

1. A method of obtaining information relating to the condition of at least one item, said method comprising the steps of:
providing an accessible electronic medium;
formulating a description relating to at least one item and entering the description in the accessible electronic medium, the description being suitable to assist in the valuation of the at least one item;
facilitating access to the accessible electronic medium in a manner to permit at least one authorized user to access the description.

2. The method according to claim 1, wherein the item comprises a vehicle.

3. The method according to claim 1, wherein the description of the at least one item comprises information relating to the condition of the at least one item.

4. The method according to claim 1, wherein the description of the at least one item comprises at least one visual representation of the at least one item.

5. The method according to claim 1, wherein the description of the at least one item comprises information relating to any damage to the physical condition of the at least one item.

6. The method according to claim 1, wherein the description of the at least one item comprises information relating to options associated with the at least one item.

7. The method according to claim 1, wherein the accessible electronic medium comprises a medium accessible via the Internet.

8. The method according to claim 1, wherein the accessible electronic medium comprises a portable electronic data storage unit.

9. The method according to claim 1, wherein the accessible electronic medium comprises a portable electronic data storage unit having an integral device for capturing images.

10. The method according to claim 1, wherein said step of facilitating access comprises providing at least one security arrangement associated with the accessible electronic medium.

11. The method according to claim 9, wherein said step of providing at least one security arrangement comprises providing an electronic cryptographic arrangement associated with the accessible electronic medium.

12. A system for obtaining information relating to the condition of at least one item, said system comprising:
an accessible electronic medium;
an arrangement for formulating a description relating to at least one item and for facilitating entry of the description into the accessible electronic medium, the description being suitable to assist in the valuation of the at least one item; and
an arrangement for facilitating access to the accessible electronic medium in a manner to permit at least one authorized user to access the description.

13. The system according to claim 12, wherein the item comprises a vehicle.

14. The system according to claim 12, wherein the description of the at least one item comprises information relating to the condition of the at least one item.

15. The system according to claim 12, wherein the description of the at least one item comprises at least one visual representation of the at least one item.

16. The system according to claim 12, wherein the description of the at least one item comprises information relating to any damage to the physical condition of the at least one item.

17. The system according to claim 12, wherein the description of the at least one item comprises information relating to options associated with the at least one item.

18. The system according to claim 12, wherein the accessible electronic medium comprises a medium accessible via the internet.

19. The system according to claim 12, wherein the accessible electronic medium comprises a portable electronic data storage unit.

20. The system according to claim 12, wherein the accessible electronic medium comprises a portable electronic data storage unit having an integral device for capturing images.

21. The system according to claim 12, wherein said access facilitating arrangement comprises at least one security arrangement associated with the accessible electronic medium.

22. The system according to claim 21, wherein said at least one security arrangement comprises an electronic cryptographic arrangement associated with the accessible electronic medium.

23. Apparatus for obtaining information relating to the condition of at least one item, said apparatus comprising:
an arrangement for electronically formulating a description relating to at least one item; the description being suitable to assist in the valuation of the at least one item; and
an arrangement for permitting at least one authorized user to access the description relating to the at least one item to assist in the valuation of the at least one item.

24. The apparatus according to claim 23, wherein the item comprises a vehicle.

25. The apparatus according to claim 23, wherein the description of the at least one item comprises information relating to the condition of the at least one item.

26. The apparatus according to claim 23, wherein the description of the at least one item comprises at least one visual representation of the at least one item.

27. The apparatus according to claim 23, wherein the description of the at least one item comprises information relating to any damage to the physical condition of the at least one item.

28. The apparatus according to claim 23, wherein the description of the at least one item comprises information relating to options associated with the at least one item.

29. The apparatus according to claim 23, wherein the accessible electronic medium comprises a medium accessible via the internet.

30. The apparatus according to claim 23, wherein the accessible electronic medium comprises a portable electronic data storage unit.

31. The apparatus according to claim 23, wherein the accessible electronic medium comprises a portable electronic data storage unit having an integral device for capturing images.

31. The apparatus according to claim 23, wherein said access facilitating arrangement comprises at least one security arrangement associated with the accessible electronic medium.

32. The apparatus according to claim 31, wherein said at least one security arrangement comprises an electronic cryptographic arrangement associated with the accessible electronic medium.

33. An apparatus for the display of information relating to the condition of at least one item, said apparatus comprising:
a display;
an arrangement for producing information for being displayed on said display, said information relating to the condition of the at least one item;
an arrangement for producing information for being displayed on said display, said information relating to the visual representation of the at least one item;
an arrangement for producing information for being displayed on said display, said information relating to any damage to the physical condition of the at least one item;
an arrangement for producing information for being displayed on said display, said information relating to options associated with the at least one item.

34. The apparatus according to claim 33, wherein said at least one item is a vehicle.

35. The apparatus according to claim 34, wherein said information relating to the condition of the at least one item comprises the year of the vehicle, the make of the vehicle, the model of the vehicle, the exact model of the vehicle, and the vehicle identification number.

36. The apparatus according to claim 34, wherein said information relating to the visual representation of the at least one item comprises at least one digital photograph of the vehicle.

37. The apparatus according to claim 34, wherein said information relating to any damage to the physical condition of the at least one item comprises an indication of the section of the vehicle in which the damage is located, the estimated cost to repair the damage, a visual representation of the damage, and a description of the damage.

38. The apparatus according to claim 34, wherein said information relating to options associated with the at least one item comprises a listing of options found in the vehicle.

39. The apparatus according to claim 33, wherein information produced for display is available solely to authorized users of the apparatus.

40. A program storage device readable by machine for tangibly embodying a program of instructions executable by said machine to perform a method of obtaining information relating to the condition of at least one item, said method comprising the steps of:
providing an accessible electronic medium;
formulating a description relating to at least one item and entering the description in the accessible electronic medium, the description being suitable to assist in the valuation of the at least one item;
facilitating access to the accessible electronic medium in a manner to permit at least one authorized user to access the description.
